(19) United States
(12) Patent Application Publication
(10) Pub. No.: US 2023/0269399 A1
(43) Pub. Date: Aug. 24, 2023

(54) VIDEO ENCODING AND DECODING USING DEEP LEARNING BASED IN-LOOP FILTER

(71) Applicants: HYUNDAI MOTOR COMPANY, Seoul (KR); KIA CORPORATION, Seoul (KR); EWHA UNIVERSITY - INDUSTRY COLLABORATION FOUNDATION, Seoul (KR)

(72) Inventors: Je Won Kang, Seoul (KR); Na Young Kim, Seoul (KR); Jung Kyung Lee, Seoul (KR); Seung Wook Park, Yongin-si (KR); Wha Pyeong Lim, Hwaseong-si (KR)

(73) Assignees: HYUNDAI MOTOR COMPANY, Seoul (KR); KIA CORPORATION, Seoul (KR); EWHA UNIVERSITY - INDUSTRY COLLABORATION FOUNDATION, Seoul (KR)

(21) Appl. No.: 18/020,375

(22) PCT Filed: Aug. 24, 2021
(86) PCT No.: PCT/KR2021/011302

§ 371 Date: Feb. 8, 2023

(30) Foreign Application Priority Data
Aug. 24, 2020 (KR) 10-2020-0106103
Aug. 24, 2021 (KR) 10-2021-0111724

(51) Int. Cl. H04N 19/86; H04N 19/172; H04N 19/105; H04N 19/82

(52) U.S. Cl. CPC H04N 19/86; H04N 19/172; H04N 19/105; H04N 19/82

(57) ABSTRACT

A video encoding method and a video decoding method is provided for generating improved picture quality for a current frame and improving encoding efficiency. The video encoding method and the video decoding method further include an in-loop filter that detects a reference region from a current frame and a reference frame using a deep learning-based detection model and then combines the detected reference region with the current frame.

### CROSS-REFERENCE TO RELATED APPLICATIONS

This application is a U.S. national stage of International Application No. PCT/KR2021/011302, filed on Aug. 24, 2021, which claims priority to Korean Patent Application No. 10-2020-0106103, filed on Aug. 24, 2020, and Korean Patent Application No. 10-2021-0111724, filed on Aug. 24, 2021, the entire disclosures of each of which are incorporated herein by reference.

### TECHNICAL FIELD

The present disclosure relates to encoding and decoding of a video. More specifically, the present disclosure relates to a video encoding method and a video decoding method. The video encoding method and the video decoding method further include an in-loop filter that detects a reference region from a current frame and a reference frame using a deep learning-based detection model and then combines the detected reference region with the current frame.

### BACKGROUND

The descriptions below provide only the background information related to the present disclosure and do not constitute the prior art.

Since video data has a large amount of data compared to audio or still image data, it requires a lot of hardware resources, including memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/AVC, High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher encoding efficiency and an improved image enhancement effect than existing compression techniques is required.

Recently, a deep learning-based video processing technology is being applied to an existing encoding element technology. The deep learning-based video processing technology is applied to a compression technology such as inter prediction, intra prediction, in-loop filter, or transform among existing encoding technologies, so as to improve encoding efficiency. Representative application examples include inter prediction based on a virtual reference frame generated on the basis of a deep learning model, and in-loop filter based on an image restoration model (see Non-patent literature 1). Therefore, in video encoding or decoding, it is necessary to consider continuous application of the deep learning-based video processing technology in order to improve encoding efficiency.

### Non-Patent Literature

Non-patent literature 1: Ren Yang, Mai Xu, Zulin Wang and Tianyi Li, Multi-Frame Quality Enhancement for Compressed Video, Arxiv:1803.04680.

Non-patent literature 2: Jongchan Park, Sanghyun Woo, Joon-Young Lee, and In So Kweon, BAM: Bottleneck Attention Module, Arxiv:1807.06514.

### SUMMARY

An object of the present disclosure is to provide a video encoding method and a video decoding method. The video encoding method and the video decoding method further include an in-loop filter that detects a reference region from a current frame and a reference frame using a deep learning-based detection model and then combines the detected reference region with the current frame to enhance the image quality of the current frame and improve encoding efficiency.

One aspect of the present disclosure provides a method performed by a video decoding apparatus to enhance the quality of a current frame. The method comprises acquiring the current frame and at least one reference frame. The method also comprises detecting a reference region on the reference frame from the reference frame and the current frame using a deep learning-based detection model and generating a detection map. The method also comprises combining the reference region with the current frame on the basis of the detection map to generate an enhanced frame.

Another aspect of the present disclosure provides an image quality enhancement apparatus. The image quality enhancement apparatus comprises an input unit configured to acquire a current frame and at least one reference frame. The image quality enhancement apparatus also comprises a reference region detector configured to detect a reference region on the reference frame from the reference frame and the current frame using a deep learning-based detection model and configured to generate a detection map. The image quality enhancement apparatus also comprises a reference region combiner configured to combine the reference region with the current frame on the basis of the detection map to enhance the image quality of the current frame.

As described above, according to the present embodiment, it is possible to provide a video encoding method and a video decoding method further. The video encoding method and the video decoding method use an in-loop filter that detects a reference region from a current frame and a reference frame using a deep learning-based detection model and then combines the detected reference region with the current frame, thereby enhancing the image quality of the current frame and improving encoding efficiency.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a schematic block diagram of an image quality enhancement apparatus according to an embodiment of the present disclosure.

FIG. 7 is a diagram illustrating a random access structure according to an embodiment of the present disclosure.

FIG. 8 is a diagram illustrating a reference region according to an embodiment of the present disclosure.

FIG. 9 is a diagram illustrating a detection model according to an embodiment of the present disclosure.

FIG. 10 is a schematic block diagram of an image quality enhancement apparatus using an in-loop filter based on a CNN model according to an embodiment of the present disclosure.

FIG. 11 is a schematic block diagram of an image quality enhancement apparatus using an in-loop filter based on a CNN model according to another embodiment of the present disclosure.

FIG. 12 is a diagram illustrating an arrangement between the image quality enhancement apparatus and components of an existing in-loop filter according to an embodiment of the present disclosure.

FIG. 13 is a flowchart of an image quality enhancement method according to an embodiment of the present disclosure.

### DETAILED DESCRIPTION

Hereinafter, embodiments of the present disclosure are described in detail with reference to drawings. When reference numerals refer to components of each drawing, it should be noted that although the same or equivalent components are illustrated in different drawings, the same or equivalent components may be denoted by the same reference numerals. Further, in describing the embodiments, a detailed description of known related configurations and functions may be omitted to avoid unnecessarily obscuring the subject matter of the embodiments.

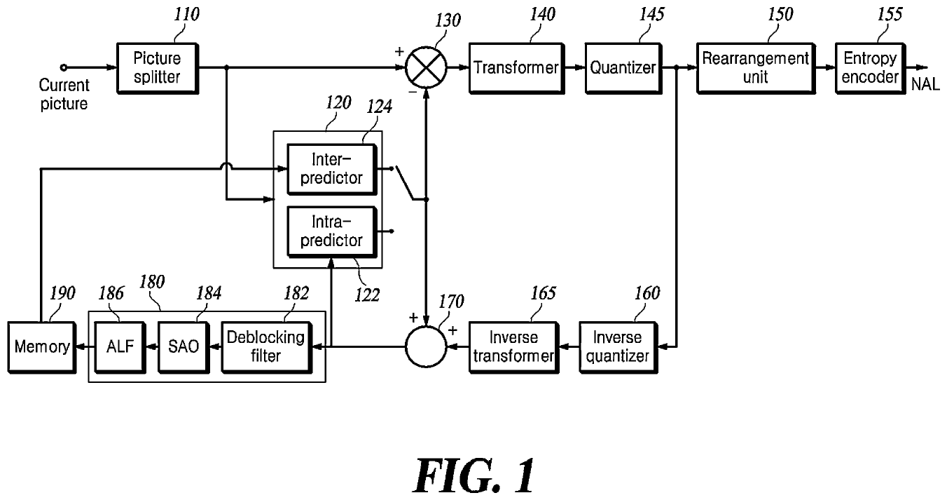

FIG. 1 is a block diagram for a video encoding apparatus which may implement technologies of the present disclosure. Hereinafter, referring to illustration of FIG. 1, the video encoding apparatus and sub-components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as the software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each CU is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information (CTU size) on the size of the CTU is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

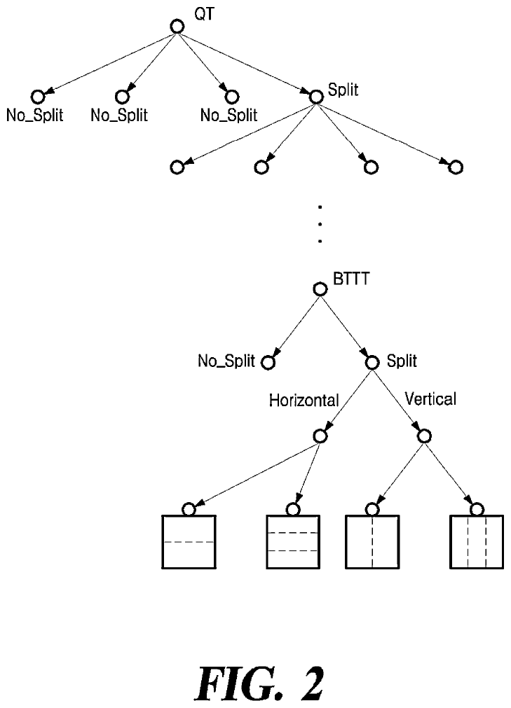

FIG. 2 is a diagram for describing a method for splitting a block by using a QTBTTT structure.

As illustrated in FIG. 2, the CTU may first split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., in a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the coding unit (CU), which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node split into two rectangular blocks having a size ratio of 1:3 or also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

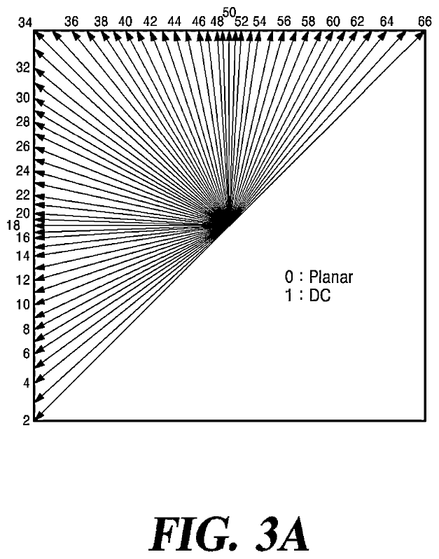

The intra predictor 122 predicts pixels in the current block by using pixels (reference pixels) positioned on a neighboring of the current block in the current picture including the current block. There are a plurality of intra prediction modes according to the prediction direction. For example, as illustrated in FIG. 3A, the plurality of intra prediction modes may include 2 non-directional modes including a planar mode and a DC mode and may include 65 directional modes. A neighboring pixel and an arithmetic equation to be used are defined differently according to each prediction mode.

For efficient directional prediction for the current block having the rectangular shape, directional modes (#67 to #80, intra prediction modes #−1 to #−14) illustrated as dotted arrows in FIG. 3B may be additionally used. The direction modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and also select an appropriate intra prediction mode to be used from tested modes. For example, the intra predictor 122 may calculate rate-distortion values by using a rate-distortion analysis for multiple tested intra prediction modes and also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of the bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and information on two motion vectors is delivered to the entropy encoder 155. Here, reference picture list 0 may be constituted by pictures before the current picture in a display order among pre-restored pictures and reference picture list 1 may be constituted by pictures after the current picture in the display order among the pre-restored pictures. However, although not particularly limited thereto, the pre-restored pictures after the current picture in the display order may be additionally included in reference picture list 0. Inversely, the pre-restored pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

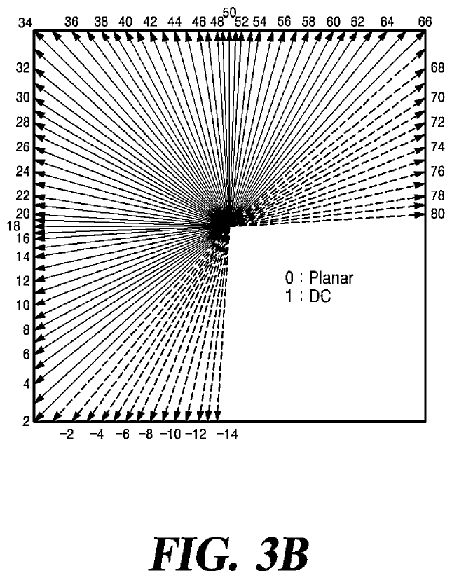

As a neighboring block for deriving the merge candidate, all or some of a left block L, a top block A, a top right block AR, a bottom left block BL, and a top left block AL adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

The merge skip mode is a special case of the merge mode. After quantization, when all transform coefficients for entropy encoding are close to zero, only the neighboring block selection information is transmitted without transmitting a residual signal. By using the merge skip mode, it is possible to achieve a relatively high encoding efficiency for images with slight motion, still images, screen content images, and the like.

Hereafter, the merge mode and the merge skip mode are collectively called the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block L, a top block A, a top right block AR, a bottom left block BL, and a top left block AL adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms a residual signal in a residual block having pixel values of a spatial domain into a transform coefficient of a frequency domain. The transformer 140 may transform residual signals in the residual block by using a total size of the residual block as a transform unit or also split the residual block into a plurality of sub-blocks and perform the transform by using the sub-block as the transform unit. Alternatively, the residual block is divided into two sub-blocks, which are a transform area and a non-transform area to transform the residual signals by using only the transform area sub-block as the transform unit. Here, the transform area sub-block may be one of two rectangular blocks having a size ratio of 1:1 based on a horizontal axis (or vertical axis). In this case, a flag (cu_sbt_flag) indicates that only the sub-block is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area sub-block may have a size ratio of 1:3 based on the horizontal axis (or vertical axis), and in this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to transform coefficients quantized arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), Exponential Golomb, etc.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to restore the residual block.

The adder 170 adds the restored residual block and the prediction block generated by the predictor 120 to restore the current block. Pixels in the restored current block are used as reference pixels when intra-predicting a next-order block.

The loop filter unit 180 performs filtering for the restored pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the restored blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating a difference between the restored pixel and an original pixel, which occurs due to lossy coding. The SAO filter 184 applies an offset as a CTU unit to enhance a subjective image quality and encoding efficiency. Contrary to this, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The restored block filtered through the deblocking filter 182, the SAO filter 184, and the ALF 186 is stored in the memory 190. When all blocks in one picture are restored, the restored picture may be used as a reference picture for inter predicting a block within a picture to be encoded afterwards.

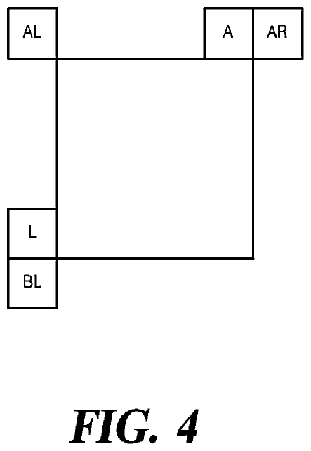

FIG. 5 is a functional block diagram for a video decoding apparatus, which may implement the technologies of the present disclosure. Hereinafter, referring to FIG. 5, the video decoding apparatus and sub-components of the apparatus are described.

The video decoding apparatus may be configured to include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU is extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (MTT_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (sub-block) of the transform block, the inverse transformer 530 extracts a flag (cu_sbt_flag) that only the sub-block of the transform block is transformed, directional (vertical/horizontal) information (cu_sbt_horizontal_flag) of the sub-block, and/or positional information (cu_sbt_pos_flag) of the sub-block. The inverse transformer 530 also inversely transforms the transform coefficients of the corresponding sub-block into the spatial domain from the frequency domain to restore the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_jdx) signaled from the video encoding apparatus. The inverse transformer 530 also performs inverse transform for the transform coefficients in the transform block in the horizontal and vertical directions by using the determined transform function.

The predictor 540 may include the intra predictor 542 and the inter predictor 544. The intra predictor 542 is activated when the prediction type of the current block is the intra prediction and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 restores the current block by adding the residual block output from the inverse transform unit output from the inverse transform unit and the prediction block output from the inter prediction unit or the intra prediction unit. Pixels within the restored current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the restored blocks in order to remove the blocking artifact, which occurs due to block unit decoding. The SAO filter 564 and the ALF 566 perform additional filtering for the restored block after the deblocking filtering in order to compensate a difference between the restored pixel and an original pixel, which occurs due to lossy coding. The filter coefficient of the ALF is determined by using information on a filter coefficient decoded from the bitstream.

The restored block filtered through the deblocking filter 562, the SAO filter 564, and the ALF 566 is stored in the memory 570. When all blocks in one picture are restored, the restored picture may be used as a reference picture for inter predicting a block within a picture to be encoded afterwards.

The present embodiment relates to encoding and decoding of a video as described above. More specifically, the present embodiment provides a video encoding method and a video decoding method further including an in-loop filter that detects a reference region from a current frame and a reference frame using a deep learning-based detection model and then combines the detected reference region with the current frame.

In the following description, the video encoding apparatus and method are used with an encoding apparatus and method, and the video decoding apparatus and method are used with a decoding apparatus and method.

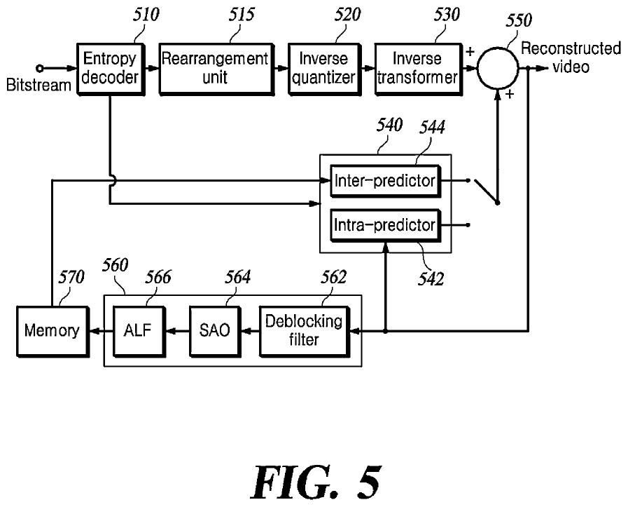

FIG. 6 is a schematic block diagram of an image quality enhancement apparatus according to an embodiment of the present disclosure.

The image quality enhancement apparatus 600 according to the present embodiment detects a reference region from a current frame and a reference frame using the deep learning-based detection model and then combines the detected region with the current frame to enhance the image quality of the current frame. The image quality enhancement apparatus 600 has a function similar to that of an in-loop filters 180 and 560 in terms of enhancement of the image quality of the current frame. The image quality enhancement apparatus 600 includes all or some of an input unit 602, a reference region detector 604, and a reference region combiner 606.

Hereinafter, the image quality enhancement apparatus 600 may be equally applied to the encoding apparatus and the decoding apparatus. However, in the case of the encoding apparatus according to the present embodiment, components included in the image quality enhancement apparatus 600 are not necessarily limited thereto. For example, the image quality enhancement apparatus 600 may additionally include a training unit (not illustrated) for training of a detection model or may be implemented in a form linked to an external training unit.

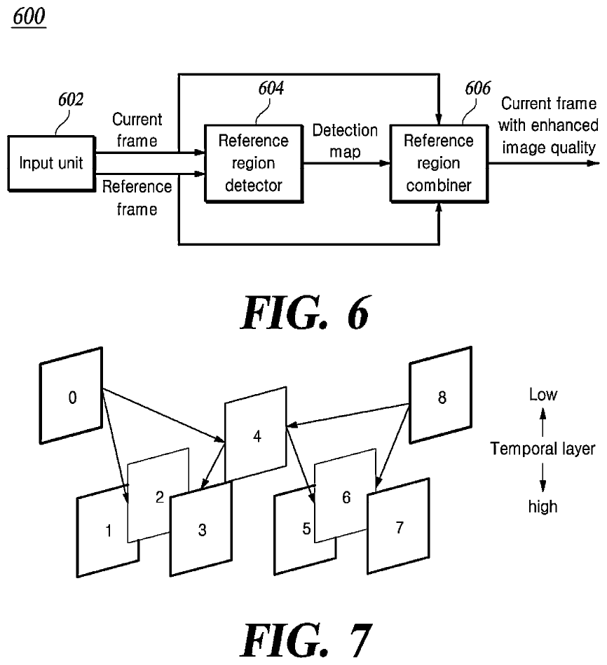

In a video encoding process, reference pictures may be encoded with different image quality. For example, as illustrated in FIG. 7, when a random access (RA) structure is assumed, an intra frame (I frame) used as a key frame is compressed to have high quality and a high peak signal to noise ratio (PSNR) using a small quantization parameter (QP). On the other hand, frames on which inter prediction is performed with reference to the I frame may be compressed to have a low PSNR using a relatively greater QP.

In addition to the I-frame, frames having a lower temporal layer among the frames on which the inter prediction is performed may become key frames. For example, in the example of FIG. 7, in the case of a frame 3, a frame 4 or a frame 2 may be used as the key frame. When the reference frame is selected, the decoding apparatus may select a frame with the smallest quantization parameter within a group of pictures (GOP) or may select a frame having a lower temporal layer than the current frame while being closest to the current frame. The decoding apparatus may select one or more reference frames and may select reference frames in both directions as well as in one direction. The example of FIG. 7 describes application to the RA structure, but a scheme for selecting the reference frame as described above is also applicable to a low delay (LD) structure.

In an embodiment according to the present disclosure, the image quality of the current frame is enhanced by using a reference frame with high image quality that is used for inter prediction, including the I frame. In the case of an existing image restoration model based on the reference frame, a large amount of training data and a large number of corresponding model parameters are required in order to universally enhance the image quality of various blocks, such as a block including a smooth region, a block including a complex texture, and a block with a lot of motion. Nevertheless, it is not an easy task to remove quantization noise having a statistically uniform distribution.

In the present embodiment, in order to enhance the image quality of the current frame, the decoding apparatus detects the reference region from the reference frame corresponding to the key frame. The deep learning-based detection model used for detection of the reference region may be trained in advance to detect the reference region from the current frame and the key frame. In this case, the detected reference region may include the same region as the current frame but may be encoded using a small quantization parameter and have relatively small quantization noise.

The image quality enhancement apparatus 600 acquires a flag indicating whether the detection model is used (hereinafter, a ‘detection model usage flag’). For example, the encoding apparatus may acquire a preset detection model usage flag and transmit the detection model usage flag and to the decoding apparatus. Accordingly, the decoding apparatus can decode the detection model usage flag from the bitstream.

When the detection model usage flag is 1, the image quality enhancement apparatus 600 performs the following image quality improvement function. On the other hand, when the detection model usage flag is 0, the encoding apparatus or the decoding apparatus may use the existing in-loop filters 180 and 560.

The input unit 602 acquires the current frame and the reference frame. The input unit 602 may select the reference frame among the reference frame candidates included in a reference picture list according to the following conditions.

When an I frame is included in the reference picture list, the input unit 602 may select the I frame as the reference frame.

The input unit 602 may select, as the reference frame, a frame whose temporal ID indicating a temporal layer is lowest among the reference frame candidates included in the reference picture list.

The input unit 602 may select, as the reference frame, a frame having a picture order count (POC) closest to the current frame, i.e., a frame closest in time, among the reference frame candidates included in the reference picture list.

The input unit 602 may select, as the reference frame, a frame whose temporal identifier indicating the temporal layer is lowest and whose POC is closest to the current frame among the reference frame candidates included in the reference picture list.

The input unit 602 may select, as the reference frame, a frame encoded with the smallest QP among the reference frame candidates included in the reference picture list.

When there are two or more reference frames satisfying the conditions as described above, the input unit 602 may select a temporally preceding frame as the reference frame.

In another embodiment according to the present disclosure, when there are two or more reference frames satisfying the conditions as described above, the input unit 602 may select them as a plurality of reference frames.

The reference region detector 604 detects a reference region on the reference frame from the reference frame and the current frame using the deep learning-based detection model and detects a detection map for indicating the reference region (a reference region detection map; hereinafter referred to as a ‘detection map’).

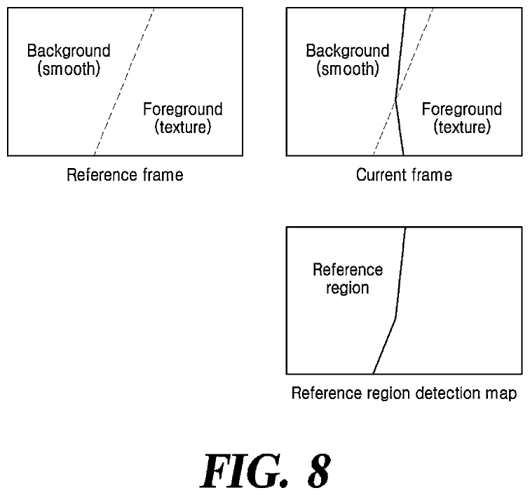

Hereinafter, an operation of the reference region detector 604 is described using an example of FIG. 8.

FIG. 8 is a diagram illustrating the reference region according to an embodiment of the present disclosure.

The reference frame includes a smooth background and a foreground with complex textures and a lot of motion. In the current frame, the background region and the foreground region may change from a dotted line boundary to a solid line boundary, for example, according to a motion of a camera. In the example of FIG. 8, a region indicated as ‘reference region’ in the reference region detection map is a region that can be used to enhance the image quality of the current frame.

The reference region detector 604 may detect a reference region including one or more regions. In this case, the reference region detector 604 generates a binary map indicating the reference region as a detection map. In the binary map, the reference region is marked with a flag 1, and a remaining region not included in the reference region (hereinafter referred to as a ‘non-reference region’) is marked with a flag 0. Later, a determination may be made as to whether or not pixels are used in the reference frame on the basis of the binary map.

In another embodiment according to the present disclosure, the reference region detector 604 may generate a detection map on a pixel-by-pixel basis probabilistically indicating the reference region and the non-reference region as a pixel value of ‘0 to 255 (2⁸−1)’ instead of the binary map. In other words, the reference region detector 604 may generate the detection map on a pixel-by-pixel basis indicating a region corresponding to the entire reference frame in a manner in which one pixel indicates one region. Thus, in the detection map on a pixel-by-pixel basis, pixels in a bright region (pixels with a value close to 255) stochastically represent a more definite reference region, and pixels in a dark region (pixels with a value closer to 0) stochastically represent a more definite non-reference region. Later, the detection map on a pixel-by-pixel basis may be used for a weighted sum between pixels of the current frame and information of the reference frame. The image quality enhancement apparatus 600 may further use information of the reference frame as the reference region is approached, and further use information of the current frame as the non-reference region is approached.

The above description shows that a pixel value of the detection map on a pixel-by-pixel basis is included in a range of ‘0 to 255’, but the pixel value is not necessarily limited thereto. In other words, when a bit depth of a pixel is set to N (where N is a natural number) bits, the pixel value of the detection map may have a range of ‘0 to 2N−1’.

In another embodiment according to the present disclosure, the reference region may be on a block-by-block basis rather than a pixel-by-pixel basis. In other words, the reference region may have the same size as a CTU or the same size as a CU or sub-CU. Alternatively, the reference region may be a set of blocks and have the same size as a tile or sub-picture.

Thus, when the reference region is on a block-by-block basis, a flag on a block-by-block basis may be shared as the detection model usage flag between the encoding apparatus and the decoding apparatus. A detection map for the block may be generated as a binary map or the detection map on a pixel-by-pixel basis by the detection model.

In particular, when the reference region is on a block-by-block basis and the detection map is a binary map, the flag on a block-by-block basis may also function as a binary map for the block. In other words, when the block is detected as the reference region by the detection model, the encoding apparatus may transmit the flag on a block-by-block basis to replace the binary map. In this case, the decoding apparatus may decode the flag on a block-by-block basis and use this as the binary map for the block, with a step of using the detection model omitted. In other words, when the decoded flag on a block-by-block basis is 1, this indicates that the block is the reference region and that a flag indicating the binary map of the block is also 1.

Meanwhile, information indicating a type of detection map, such as a binary map or the detection map on a pixel-by-pixel basis, should be shared between the encoding apparatus and the decoding apparatus. For example, the encoding apparatus may acquire a preset type of detection map and transmit the type of detection map to the decoding apparatus. Therefore, the decoding apparatus can decode the type of detection map from the bitstream.

In another embodiment according to the present disclosure, as described above, when there are a plurality of (for example, M; M is a natural number equal to or greater than 2) reference frames, the reference region detector 604 may use the detection model M times to detect the reference region for each reference frame. In other words, the reference region detector 604 may input the current frame and one reference frame to the detection model, detect the reference region for each reference frame, and generate M corresponding detection maps. In this case, all the M detection maps may be binary maps. Alternatively, all the M detection maps may be detection maps on a pixel-by-pixel basis.

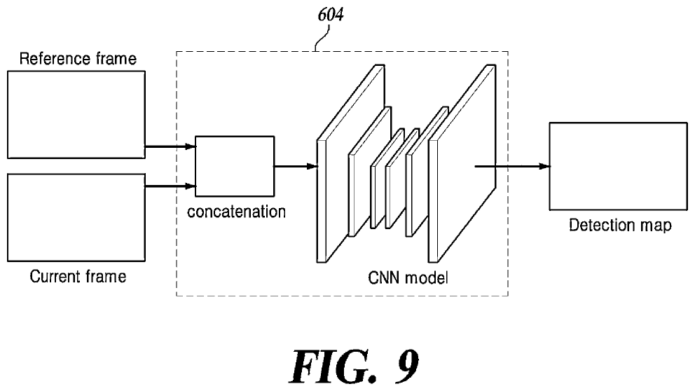

FIG. 9 is a diagram illustrating the detection model according to an embodiment of the present disclosure.

A convolutional neural network (CNN) model as illustrated in FIG. 9 may be used as a deep learning-based detection model. The current frame and the reference frame may be concatenated and input to the detection model. The detection model may have a structure in which n (n is a natural number) convolutional layers are combined.

The detection model used for detection of the reference region may have a much simpler configuration than a model for improving image quality or estimating a motion. Further, the detection model may express various resolutions by using a change in a size of a kernel and stride of the convolutional layer, and pooling.

The detection model may generate the detection map on a pixel-by-pixel basis as an output when a last layer is implemented with an activation function such as a sigmoid function. Alternatively, for example, in the case of the detection map on a pixel-by-pixel basis expressed by pixel values of ‘0 to 255’, a range of ‘0 to 127’ is assigned to a flag 0 and a range of ‘128 to 255’ is assigned to a flag 1, making it possible for the detection model to create a binary map.

Meanwhile, the detection model may generate a detection map using a convolutional layer as illustrated in FIG. 9 but may also generate an attention map (see Non-patent literature 2). In another embodiment according to the present disclosure, the detection model may sequentially apply downsampling, upsampling, and a softmax layer to a feature map generated by the convolutional layer to generate the attention map.

Meanwhile, the training unit may pre-train the detection model on the basis of training data and a corresponding label so that the detection model can detect the reference region. Here, the training data includes a current frame and a reference frame for learning, and the label may be the binary map corresponding to the reference frame that has undergone a process of selecting as described above.

The reference region combiner 606 combines the reference region with the current frame on the basis of the detection map to improve image quality.

When the detection map is a binary map, the reference region combiner 606 may enhance the image quality of the current frame and generate an enhanced frame pᵢₘ(i, j) as shown in Equation 1.

$${p}_{im} ( i , j ) = \{ \begin{matrix}{p}_{ref} ( i , j ) , & if map ( i , j ) = 1 \\ p ( i , j ) , & otherwise\end{matrix} \qquad [ Equation 1 ]$$

Here, p(i, j) is a (i, j) pixel of the current frame, and p_{ref}(i, j) is a (i, j) pixel of the reference frame. Further, map(i, j) is the detection map and indicates a binary flag of the reference region at a position (i, j). As shown in Equation (1), the reference region combiner 606 replaces the pixel of the current frame with a pixel of the reference region when a binary flag of the detection map is 1 and maintains the pixel value of the current frame when the binary flag is 0.

In another embodiment according to the present disclosure, when the reference region is on a block-by-block basis and the detection map is the binary map as described above, the flag on a block-by-block basis may replace the function of the binary map for the block. The reference region combiner 606 may use the block as the reference region when the flag on a block-by-block basis of the block is 1 and use the current block as it is when the flag on a block-by-block basis is 0. Further, the decoding apparatus combines the current block by using the reference region on the basis of the flag on a block-by-block basis, with the step of using the detection model for generating the detection map omitted, thereby reducing the complexity of the decoding apparatus.

In another embodiment according to the present disclosure, when a reference region is detected for each of a plurality of (for example, M; M is a natural number greater than or equal to 2) reference frames as described above, the reference region combiner 606 may generate the enhanced frame pᵢₘ(i, j), as shown in Equation 2, using each reference region-specific detection map mapₘ(i, j) (where, 1≤m≤M).

$${p}_{im} ( i , j ) = \{ \begin{matrix}{\sum }_{m = 1}^{MM} {a}_{m} {p}_{ref , m} ( i , j ) , & otherwise \\ p ( i , j ) , & if {map}_{m} ( i , j ) = 0 for ∀ m\end{matrix} \qquad [ Equation 2 ]$$

Here, MM (1≤MM≤M) is the number of reference frames satisfying ‘mapₘ(i, j)=1’, and p_{ref,m}(i, j) is a (i, j) pixel of an m-th reference frame. Further, am is a weight, and a sum of MM weights is 1. When MM binary flags are 1 for M detection maps (that is, when there is at least one reference region having a flag of 1), the reference region combiner 606 may perform a weighted sum on pixel values of MM reference regions to replace the pixel of the current frame, as shown in Equation 2. On the other hand, when all of the binary flags of the M detection maps are 0, the reference region combiner 606 maintains the pixel values of the current frame.

Meanwhile, as described above, M reference frames may be sequentially selected according to a method for selecting the reference frame among the reference frame candidates included in the reference picture list. For example, when ‘M=4’, the I frame is selected as a first reference frame. As a second reference frame, a frame having the lowest time identifier is selected among the remaining candidates. As a third reference frame, the frame whose POC is the closest to the current frame is selected among the remaining candidates. As a fourth reference frame, frames encoded with the smaller QP may be selected among the remaining candidates, and then a temporally preceding frame may be selected from the frames.

In another embodiment according to the present disclosure, when map(i, j) is the detection map on a pixel-by-pixel basis represented by the pixel values of ‘0 to 255’, the reference region combiner 606 may use a range of ‘0 to 127’ as a flag 0 and a range of ‘128 to 255’ as a flag 1.

Alternatively, the reference region combiner 606 may perform a weighted sum using the pixel values of ‘0 to 255’ on the detection map as they are, to generate the enhanced frame pᵢₘ(i, j), as shown in Equation 3.

$${p}_{im} ( i , j ) = ( 1 - \frac{map ( i , j )}{255} ) \cdot p ( i , j ) + \frac{map ( i , j )}{255} \cdot {p}_{ref} ( i , j ) \qquad [ Equation 3 ]$$

When the reference region is detected for each of the M reference frames, the reference region combiner 606 may use each reference region-specific detection map mapₘ(i, j) (where 1≤m≤M) to generate the enhanced frame pᵢₘ(i, j), as shown in Equation 4.

$${p}_{im} ( i , j ) = ( 1 - {\sum }_{m = 1}^{M} {a}_{m} \cdot \frac{{map}_{m} ( i , j )}{255} ) p ( i , j ) + {\sum }_{m = 1}^{M} {a}_{m} \frac{{map}_{m} ( i , j )}{255} {p}_{ref , m} ( i , j ) \qquad [ Equation 4 ]$$

Here, mapₘ(i, j) is the detection map on a pixel-by-pixel basis represented by pixel values of ‘0 to 255’.

In another embodiment according to the present disclosure, the image quality enhancement apparatus 600 may be combined with the existing in-loop filter in the encoding apparatus or the decoding apparatus. For example, the image quality enhancement apparatus 600 may apply separate functions f and g to p(i, j) and p_{ref}(i, j), respectively, and then perform a weighted sum using pixel values of ‘0’ to 255’ on the detection map on a pixel-by-pixel basis, to generate the enhanced frame pᵢₘ(i, j), as shown in Equation 5.

$${p}_{im} ( i , j ) = ( 1 - \frac{map ( i , j )}{255} ) \cdot f ( p ( i , j ) ) + \frac{map ( i , j )}{255} \cdot g ( {p}_{ref} ( i , j ) ) \qquad [ Equation 5 ]$$

In Equation 5, the image quality enhancement apparatus 600 may apply both the functions f and g or apply either f or g. Further, f and g may be the same function.

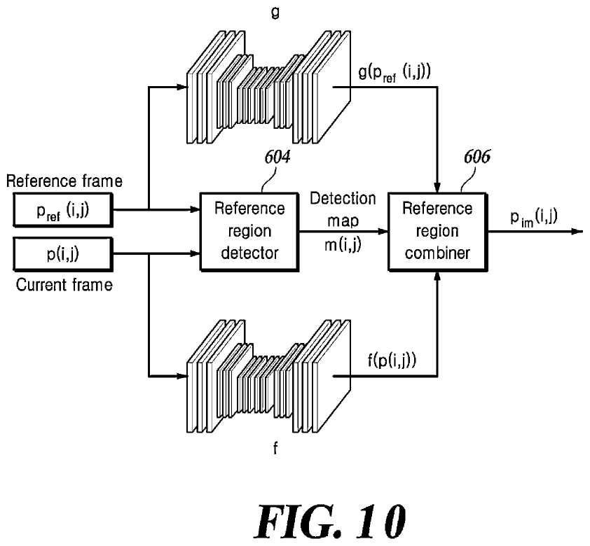

The functions f and g may be a combination of at least one of components of the existing in-loop filter. Further, the functions f and g may be in-loop filters based on a CNN model (see Non-patent literature 1), as illustrated in FIG. 10.

In another embodiment according to the present disclosure, the image quality enhancement apparatus 600 may generate the enhanced frame pᵢₘ(i, j) using the binary flag on the detection map, as shown in Equation 6.

$${p}_{im} ( i , j ) = \{ \begin{matrix}{p}_{ref} ( i , j ) , & if map ( i , j ) = 1 \\ f ( p ( i , j ) ) , & otherwise\end{matrix} \qquad [ Equation 6 ]$$

The image quality enhancement apparatus 600 enhances the image quality by using the reference region when the binary flag is 1, and the image quality enhancement apparatus 600 enhances the image quality by applying the function f to the pixels of the current frame when the binary flag is 0.

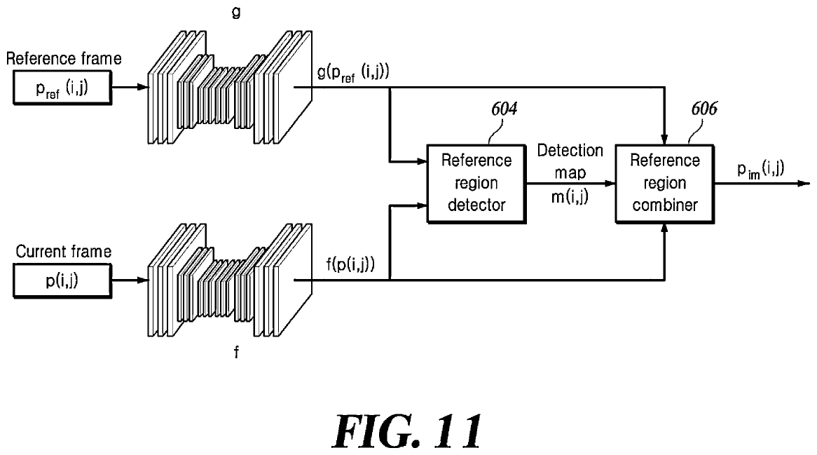

In another embodiment according to the present disclosure, the image quality enhancement apparatus 600 may receive the current frame and the reference frame to which the separate functions f and g have been applied, respectively, as inputs, detect reference regions, and generate a detection map, as illustrated in FIG. 11. The image quality enhancement apparatus 600 may generate the enhanced frame pᵢₘ(i, j) as shown in Equation 5 or 6 according to a feature of the generated detection map.

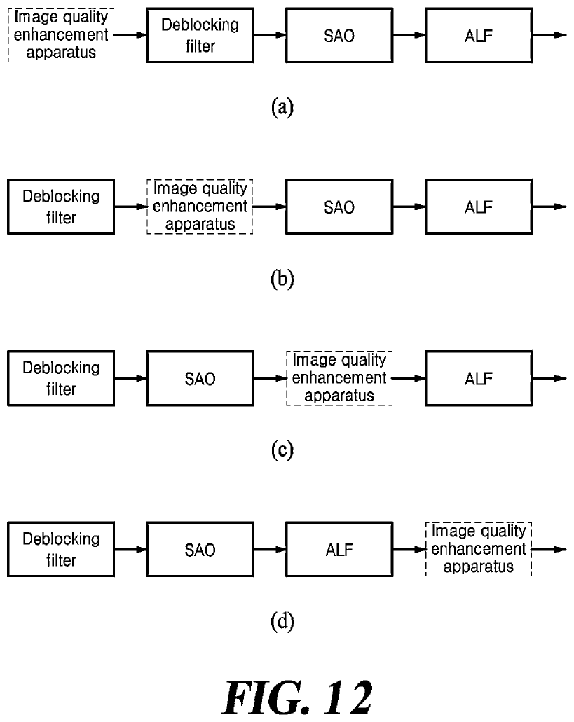

The image quality enhancement apparatus 600 may be disposed at a state after the existing in-loop filter, as shown in Equation 5 or Equation 6. Further, the enhanced frame generated by the image quality enhancement apparatus 600 may be provided as an input to the existing in-loop filter. In other words, the image quality enhancement apparatus 600 according to the present embodiment is similar to a function of the in-loop filter in terms of enhancement of the image quality of the current frame. Accordingly, the image quality enhancement apparatus 600 may be arranged as one component of the in-loop filter together with components of the existing in-loop filter, as illustrated in FIG. 12. An arrangement having the highest encoding efficiency among arrangements illustrated in FIG. 12 may be finally selected.

The image quality enhancement apparatus 600 according to the present disclosure may have fixed parameters. In other words, the encoding apparatus and the decoding apparatus may use the reference region detector 604 and the reference region combiner 606 having the same kernel, that is, the fixed parameters. Accordingly, after the encoding apparatus or the external training unit trains the deep learning-based detection model once, parameters of the detection model may be shared between the encoding apparatus and the decoding apparatus.

In another embodiment according to the present disclosure, the image quality enhancement apparatus 600 may have variable parameters. The encoding apparatus transmits a kernel of a detection model having some of all parameters as the variable parameters that are used for detection of the reference region to the decoding apparatus. The decoding apparatus generates the detection map using a previously restored reference frame and detection model and then enhances the image quality of the current frame by using the detection map.

In this case, the encoding apparatus may transmit the parameters once for each GOP but may transmit the parameters twice or more for each GOP according to a key frame selection scheme. For example, in the example of FIG. 7, when frames with POCs 1 to 3 use frames 0 and 4 as key frames and frames with POCs 5 to 7 use frames 4 and 8 as key frames, the encoding apparatus may transmit parameters to be applied to the frames 1 to 3 and parameters to be applied to the frames 5 to 7. Meanwhile, the training unit may generate the variable parameters by updating some of all parameters of the detection model according to such a parameter transmission scenario.

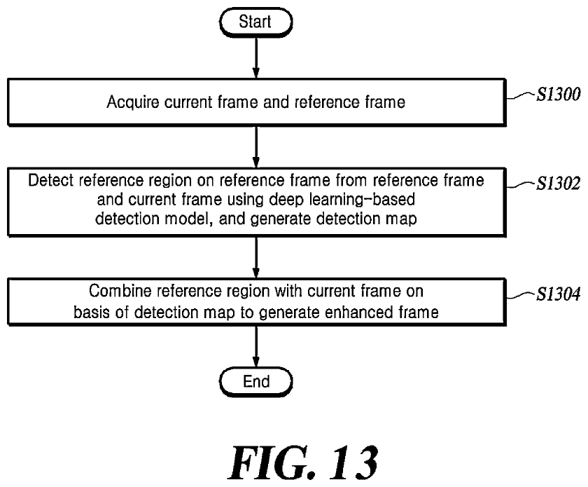

Hereinafter, an image quality enhancement method performed by the image quality enhancement apparatus 600 to enhance the image quality of the current frame is described using a flowchart of FIG. 13. When the detection model usage flag is 1 as described above, the image quality enhancement method may be equally performed by the decoding apparatus and the encoding apparatus. The encoding apparatus may also perform training of a detection model used for enhancement of image quality.

Further, the information indicating the type of detection map should be shared between the encoding apparatus and the decoding apparatus. For example, the encoding apparatus may acquire the preset type of detection map and transmit the type of detection map to the decoding apparatus. Therefore, the decoding apparatus can decode the type of detection map from the bitstream.

FIG. 13 is a flowchart of the image quality enhancement method according to an embodiment of the present disclosure.

The image quality enhancement apparatus 600 acquires the current frame and the reference frame (S1300).

The image quality enhancement apparatus 600 may select at least one reference frame among the reference frame candidates included in the reference picture list according to the following condition.

When an I frame is included in the reference picture list, the image quality enhancement apparatus 600 selects the I frame as the reference frame.

The image quality enhancement apparatus 600 may select, as the reference frame, a frame whose temporal identifier indicating a temporal layer is lowest among the reference frame candidates included in the reference picture list. The image quality enhancement apparatus 600 may also select, as the reference frame, the frame whose POC is closest to the current frame. The image quality enhancement apparatus 600 may also select, as the reference frame, a frame whose temporal identifier is lowest and whose POC is closest to the current frame. The image quality enhancement apparatus 600 may also select, as the reference frame, a frame encoded with the smallest quantization parameter.

When there are two or more reference frames satisfying the conditions as described above, the image quality enhancement apparatus 600 may select a temporally preceding frame as the reference frame.

In another embodiment according to the present disclosure, when there are two or more reference frames satisfying the conditions as described above, the image quality enhancement apparatus 600 may select them as a plurality of reference frames.

The image quality enhancement apparatus 600 detects a reference region on the reference frame from the reference frame and the current frame using the deep learning-based detection model and generates the detection map (S1302).

The image quality enhancement apparatus 600 may detect a reference region including one or more regions. In this case, the image quality enhancement apparatus 600 generates the binary map as the detection map. In the binary map, the reference region is marked with a flag 1 and the non-reference region is marked with a flag 0.

In another embodiment according to the present disclosure, the image quality enhancement apparatus 600 may generate the detection map on a pixel-by-pixel basis probabilistically indicating the reference region and the non-reference region with pixel values in a preset range instead of the binary map. In other words, the reference region detector 604 may generate the detection map on a pixel-by-pixel basis indicating the region corresponding to the entire reference frame in a manner in which one pixel indicates one region.

In another embodiment according to the present disclosure, the reference region may be on a block-by-block basis rather than a pixel-by-pixel basis. In other words, the reference region may have the same size as a CTU or the same size as a CU or sub-CU. Alternatively, the reference region may be a set of blocks and have the same size as a tile or sub-picture.

A CNN model may be used as a deep learning-based detection model. The current frame and the reference frame may be concatenated and input to the detection model. The detection model may have a structure in which n (n is a natural number) convolutional layers are combined. The detection model may generate, as an output, the binary map or the detection map on a pixel-by-pixel basis as described above.

Meanwhile, the training unit may pre-train the detection model on the basis of the training data and the corresponding label so that the detection model can detect the reference region. Here, the training data may include a current frame and a reference frame for learning, and the label may be a binary map corresponding to the reference frame that has undergone the process of selecting as described above.

In another embodiment according to the present disclosure, when there are M (M is a natural number equal to or greater than 2) reference frames, the image quality enhancement apparatus 600 may detect the reference region of each of the M reference frames using the detection model M times and generate M corresponding detection maps. In this case, all the M detection maps may be binary maps. Alternatively, all the M detection maps may be detection maps on a pixel-by-pixel basis.

The image quality enhancement apparatus 600 combines the reference region with the current frame on the basis of the detection map to generate the enhanced frame (S1304).

When the enhanced frame is generated on the basis of the binary map, the image quality enhancement apparatus 600 replaces the pixel of the current frame with the pixel of the reference region when the binary flag of the detection map is 1 and maintains the pixel values of the current frame when the binary flag is not 1.

As another embodiment according to the present disclosure, when the enhanced frame is generated on the basis of the binary map, the image quality enhancement apparatus 600 replaces the pixel of the current frame with the pixel of the reference region when the binary flag of the detection map is 1 and applies a separate function to the current frame to generate the pixel value when the binary flag is not 1. Here, the separate function may be a concatenation of at least one of the components of the in-loop filter or may be an in-loop filter based on a CNN model.

Meanwhile, when the detection map on a pixel-by-pixel basis is used, the image quality enhancement apparatus 600 may perform a weighted sum on the current frame and the reference frame on a pixel-by-pixel basis using pixel values on the detection map to generate the enhanced frame.

In another embodiment according to the present disclosure, when the detection map on a pixel-by-pixel basis is used, the image quality enhancement apparatus 600 may perform a weighted sum on the current frame and the reference frame to which the separate functions have been respectively applied, on a pixel-by-pixel basis, using the pixel values on the detection map to generate the enhanced frame.

In another embodiment according to the present disclosure, when the enhanced frame is generated in a case in which the M detection maps are binary maps, the image quality enhancement apparatus 600 performs a weighted sum on the pixel values of the reference regions having the binary flag of 1 to replace the pixels of the current frame and maintains the pixel values of the current frame when all the binary flags of the M detection maps are 0.

As described above, according to the present embodiment, it is possible to enhance the image quality of the current frame and improve coding efficiency by providing the image quality enhancement apparatus that detects the reference region from the current frame and the reference frame using the deep learning-based detection model and then combines the detected reference region with the current frame.

In each flowchart according to the embodiment, it is described that respective processes are executed in sequence, but the present disclosure is not limited thereto. In other words, since it is applicable that the processes described in the flowchart are changed and executed or one or more processes are executed in parallel, the flowchart is not limited to a time series order.

Meanwhile, various functions or methods described in the present disclosure may also be implemented by instructions stored in a non-transitory recording medium, which may be read and executed by one or more processors. The non-transitory recording medium includes, for example, all types of recording devices storing data in a form readable by a computer system. For example, the non-transitory recording medium includes storage media such as an erasable programmable read only memory (EPROM), a flash drive, an optical driver, a magnetic hard drive, and a solid state drive (SSD).

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, one of ordinary skill in the art should understand the scope of the present disclosure is not to be limited by the above explicitly described embodiments but by the claims and equivalents thereof.

### REFERENCE NUMERALS

180: in-loop filter
600: image quality enhancement apparatus
602: input unit
604: reference region detector
606: reference region combiner
560: in-loop filter

1. A method performed by a video decoding apparatus to enhance the quality of a current frame, the method comprising:
acquiring the current frame and at least one reference frame;
detecting a reference region on the reference frame from the reference frame and the current frame using a deep learning-based detection model, and generating a detection map; and
combining the reference region with the current frame on the basis of the detection map to generate an enhanced frame.

2. The method of claim 1, wherein the acquiring of the reference frame includes selecting an Intra frame (I frame) as the reference frame when the intra frame is included in a reference picture list.

3. The method of claim 2, wherein the acquiring of the reference frame includes selecting, as the reference frame, a frame whose temporal layer is lowest among reference frame candidates included in the reference picture list, selecting, as the reference frame, a frame whose picture order count (POC) is closest to the current frame, or selecting, as the reference frame, a frame encoded with a smallest quantization parameter.

4. The method of claim 1, wherein the generating of the detection map includes generating a binary map in which the reference region is marked with a flag 1 and a remaining region not included in the reference region is marked with a flag 0.

5. The method of claim 4, wherein the generating of the enhanced frame includes replacing pixels of the current frame with pixels of the reference region when a binary flag of the detection map is 1 and maintaining the pixel value of the current frame when the binary flag is not 1.

6. The method of claim 4, wherein the generating of the enhanced frame includes replacing pixels of the current frame with pixels of the reference region when a binary flag of the detection map is 1 and applying a preset function to the current frame to generate the pixel value when the binary flag is not 1.

7. The method of claim 1, wherein the generating of the detection map includes representing pixels of the reference region and remaining regions not included in the reference region with pixel values within a preset range, to generate a detection map on a pixel-by-pixel basis.

8. The method of claim 7, wherein the generating of the enhanced frame includes performing a weighted sum on the current frame and the reference frame on a pixel-by-pixel basis using pixel values on the detection map on a pixel-by-pixel basis to generate the enhanced frame.

9. The method of claim 7, wherein the generating of the enhanced frame includes performing a weighted sum on the current frame and the reference frame to which a preset function has been applied, respectively, on a pixel-by-pixel basis using pixel values on the detection map on a pixel-by-pixel basis to generate the enhanced frame.

10. The method of claim 1, wherein the generating of the detection map includes detecting a reference region of each of M (M is a natural number equal to or greater than 2) reference frames using the detection model M times when there are the M reference frames, and generating M corresponding detection maps.

11. The method of claim 10, wherein the generating of the enhanced frame includes performing a weighted sum on pixel values of reference regions having binary flags of 1 to replace pixels of the current frame when the M detection maps are binary maps and maintaining pixel values of the current frame when all binary flags of the M detection maps are 0.

12. The method of claim 1, wherein the detection model is implemented as a convolutional neural network (CNN) model, the detection model receiving a concatenation of the current frame and the reference frame as an input and generating the detection map.

13. An image quality enhancement apparatus comprising:
an input unit configured to acquire a current frame and at least one reference frame;
a reference region detector configured to detect a reference region on the reference frame from the reference frame and the current frame using a deep learning-based detection model, and generate a detection map; and
a reference region combiner configured to combine the reference region with the current frame on the basis of the detection map to enhance the image quality of the current frame.

14. The image quality enhancement apparatus of claim 13, wherein the reference region detector generates a binary map in which the reference region is marked with a flag 1 and a remaining region not included in the reference region is marked with a flag 0.

15. The image quality enhancement apparatus of claim 14, wherein the reference region combiner replaces pixels of the current frame with pixels of the reference region when a binary flag of the detection map is 1, and the reference region combiner maintains the pixel value of the current frame when the binary flag is not 1.

16. The image quality enhancement apparatus of claim 14, wherein the reference region combiner replaces pixels of the current frame with pixels of the reference region when a binary flag of the detection map is 1, and the reference region combiner applies a preset function to the current frame to generate the pixel value when the binary flag is not 1.
